(19) United States
(12) Patent Application Publication
(10) Pub. No.: US 2010/0082258 A1
(43) Pub. Date: Apr. 1, 2010

(54) SYSTEM AND METHOD FOR MODELING FLUID FLOW PROFILES IN A WELLBORE

(75) Inventor: XiaoWei Wang, Houston, TX (US)

Correspondence Address: CANTOR COLBURN LLP- BAKER HUGHES INCORPORATED, 20 Church Street, 22nd Floor, Hartford, CT, 06103, US

(73) Assignee: BAKER HUGHES INCORPORATED, Houston, TX (US)

(21) Appl. No.: 12/512,115

(22) Filed: Jul. 30, 2009

Related U.S. Application Data
(60) Provisional application No. 61/100,310, filed on Sep. 26, 2008.

(51) Int. Cl. G06F 19/00; G01V 8/00; G01V 9/00

(52) U.S. Cl. 702/12

(57) ABSTRACT

A system for measuring a fluid flow rate in a wellbore disposed in an earth formation is disclosed. The system includes: a wellbore assembly configured to be disposed along a length of a wellbore, the wellbore configured to receive a wellbore fluid therein; a distributed temperature sensor (DTS) assembly disposed along the length of the wellbore and configured to take a plurality of temperature measurements along the length of the wellbore; and a processor in operable communication with the fiber optic sensor, the processor configured to receive the temperature measurements and apply a fluid flow rate model of fluid flow rates to the temperature measurements to calculate a fluid flow profile of the wellbore. The model is based on a steady-state energy balance between the wellbore fluid and the earth formation and a Joule-Thomson coefficient including a liquid volume expansion factor and a fraction of gas in the wellbore fluid.

### CROSS REFERENCE TO RELATED APPLICATION

This application claims priority to U.S. provisional application, 61/100,310, filed Sep. 26, 2008, the entire contents of which are incorporated herein by reference.

### BACKGROUND

Temperature and fluid flow measurements of wellbores in earth formations are utilized to monitor downhole conditions so that production decisions can be made without direct wellbore intervention. Examples of temperature measurement systems include Distributed Temperature Sensing (DTS) technologies, which utilize fiber optic cables or other devices capable of measuring temperature values at multiple locations along the length of a wellbore. DTS can be used to measure, for example, a continuous temperature profile along the wellbore. This profile can in turn be used to calculate the flow rate of drilling mud and/or formation fluids in the wellbore. However, such analysis is extremely complex, which limits it as a flow allocation technique.

### SUMMARY

A system for measuring a fluid flow rate in a wellbore disposed in an earth formation includes: a wellbore assembly configured to be disposed along a length of a wellbore, the wellbore configured to receive a wellbore fluid therein; a distributed temperature sensor (DTS) assembly disposed along the length of the wellbore and configured to take a plurality of temperature measurements along the length of the wellbore; and a processor in operable communication with the fiber optic sensor, the processor configured to receive the temperature measurements and apply a fluid flow rate model of fluid flow rates to the temperature measurements to calculate a fluid flow profile of the wellbore. The model is based on a steady-state energy balance between the wellbore fluid and the earth formation and a Joule-Thomson coefficient including a liquid volume expansion factor and a fraction of gas in the wellbore fluid.

A method of measuring a fluid flow rate in a wellbore disposed in an earth formation includes: disposing a wellbore assembly along a length of the wellbore; circulating wellbore fluid through an interior of the wellbore; taking a plurality of temperature measurements along the length of the wellbore by a distributed temperature sensor (DTS) assembly disposed along the length of the wellbore; and applying a fluid flow rate model to the temperature measurements to calculate a fluid flow profile of the wellbore. The model is based on a steady-state energy balance between the wellbore fluid and the earth formation and a Joule-Thomson coefficient including a liquid volume expansion factor and a fraction of gas in the wellbore fluid.

A computer program product is stored on machine readable media for measuring a fluid flow rate in a wellbore disposed in an earth formation by executing machine implemented instructions. The instructions are for: disposing a wellbore assembly along a length of the wellbore; circulating wellbore fluid through an interior of the wellbore; taking a plurality of temperature measurements along the length of the wellbore by a distributed temperature sensor (DTS) assembly disposed along the length of the wellbore; and applying a fluid flow rate model of fluid flow rates to the temperature measurements to calculate a fluid flow profile of the wellbore. The model is based on a steady-state energy balance between the wellbore fluid and the earth formation and a Joule-Thomson coefficient including a liquid volume expansion factor and a fraction of gas in the wellbore fluid.

### BRIEF DESCRIPTION OF THE DRAWINGS

The following descriptions should not be considered limiting in any way. With reference to the accompanying drawings, like elements are numbered alike:

FIG. 1 depicts an embodiment of a well logging and/or drilling system;

FIG. 2 is a flow chart providing an exemplary method of calculating temperature and/or fluid flow profile of the wellbore of FIG. 1 by applying temperature measurements to a fluid profile model;

FIG. 3 depicts a segment of the wellbore of FIG. 1 including a non-production zone;

FIG. 4 depicts a segment of the wellbore of FIG. 1 including a production zone;

FIG. 5 illustrates wellbore fluid temperatures relative to depth due to a Joule-Thomson effect at various Bottom Hole pressure (BHPs) with constant near wellbore drawdown (e.g., 250 psi);

FIG. 6 is a flow chart showing a forward simulation method that involves applying the fluid profile model of FIG. 2;

FIG. 7 illustrates an exemplary temperature profile calculated for gas lift surveillance by the method of FIG. 6 in comparison to field data;

FIG. 8 is a flow chart showing a method of applying the fluid flow profile model of FIG. 2 to estimate fluid flow profile parameters based on measured temperatures; and

FIG. 9 illustrates an exemplary flow rate profile calculated by the method of FIG. 8 in comparison with flow profile data resulting from analysis through a conventional Production Logging Tools (PLT) test.

### DETAILED DESCRIPTION OF THE INVENTION

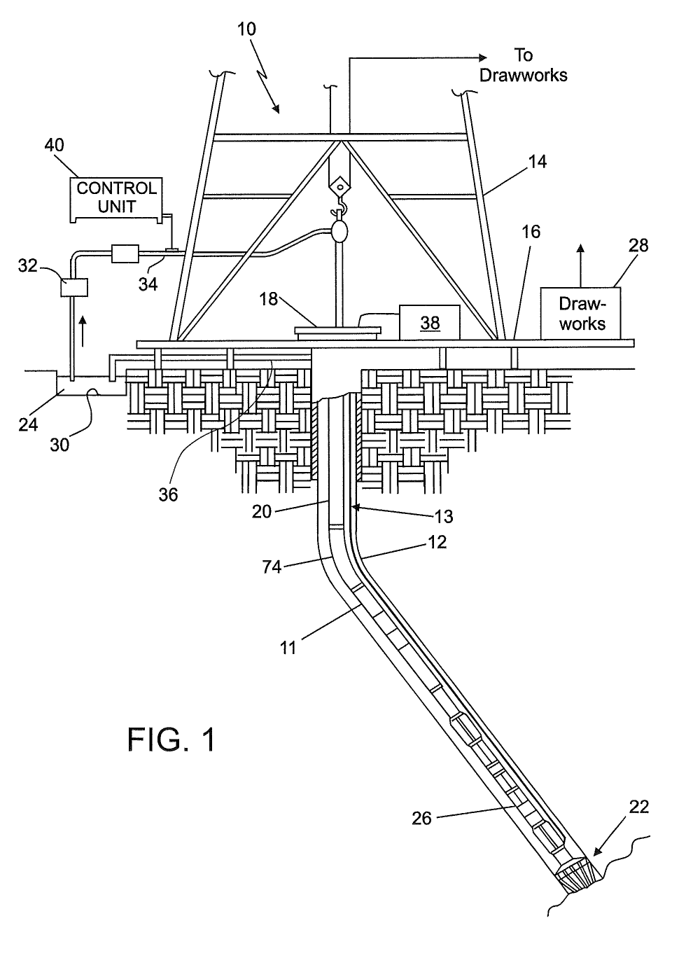

Referring to FIG. 1, an exemplary embodiment of a well drilling and/or geosteering system 10 includes a drillstring 11 that is shown disposed in a borehole 12 that penetrates at least one earth formation during a drilling and/or hydrocarbon production operation. As described herein, “borehole” or “wellbore” refers to a single hole that makes up all or part of a drilled well. As described herein, “formations” refer to the various features and materials that may be encountered in a subsurface environment. Accordingly, it should be considered that while the term “formation” generally refers to geologic formations of interest, that the term “formations,” as used herein, may, in some instances, include any geologic points or volumes of interest (such as a survey area). In addition, it should be noted that “drillstring” as used herein, refers to any structure suitable for being lowered into a wellbore or for connecting a drill or downhole tool to the surface, and is not limited to the structure and configuration described herein. For example, the drillstring 11 is configured as a hydrocarbon production string.

A distributed temperature sensor (DTS) assembly 13 is disposed along a selected length of the drillstring 11. In one embodiment, the DTS assembly 13 extends along the entire length of the drillstring between the surface and the drill bit assembly. The DTS assembly 13 is configured to measure temperature continuously or intermittently along a selected length of the wellbore 12. The DTS assembly 13 includes an optical fiber along the length of the wellbore, that uses physical phenomena such as Ramen scattering which transduces temperature into an optical signal. Temperature measurements collected via the DTS assembly 13 are used in a model to estimate fluid flow parameters in the wellbore 12.

In one embodiment, the system 10 includes a conventional derrick 14 mounted on a derrick floor 16 that supports a rotary table 18 that is rotated by a prime mover at a desired rotational speed. The drillstring 11 includes one or more drill pipe sections 20 or coiled tubing that extend downward into the wellbore 12 from the rotary table 18, and is connected to a drill bit 22. Drilling fluid, or drilling mud 24 is pumped through the drillstring 11 and/or the wellbore 12. The well drilling system 10 also includes a bottomhole assembly (BHA) 26.

In one embodiment, the drillstring 11 is coupled to a drawworks 28. During the drilling operation the drawworks 32 is operated to control drilling parameters such as the weight on bit and the rate of penetration (“ROP”) of the drillstring 11 into the wellbore 12.

During drilling operations a suitable drilling fluid 24 from a mud pit 30 is circulated under pressure through the drillstring 11 by a mud pump 32. The drilling fluid 24 passes from the mud pump 32 into the drillstring 11 via a fluid line 34. The drilling fluid is discharged at a wellbore bottom through an opening in the drill bit 22. The drilling fluid circulates uphole between the drill string 11 and the wellbore 12 and is discharged into the mud pit 30 via a return line 36.

In one embodiment, the DTS assembly 13 is connected in operable communication with a light source such as a laser, which may be disposed in a surface unit such as a DTS box 38. In one embodiment, the DTS box 38 includes components such as a light sensor for detecting back-scattered radiation and a processor for collecting data from the back-scattering and calculating the distributed temperature. In another embodiment, the processor is configured to apply the fluid flow model to determine a flow profile.

Raman back-scatter is caused by molecular vibration in the optical fiber as a result of incident light, which causes emission of photons that are shifted in wavelength relative to the incident light. Positively shifted photons, referred to as Stokes back-scatter, are independent of temperature. Negatively shifted photons, referred to as Anti-Stokes back-scatter, are dependent on temperature. Accordingly, an intensity ratio of Stokes to Anti-Stokes back-scatter may be used by the DTS box 38 to calculate temperature.

Although the distributed sensors are described in this embodiment as disposed within the drillstring 11, the distributed sensors may be used in conjunction with any structure suitable to be lowered into a wellbore, such as a production string or a wireline.

In one embodiment, the DTS assembly 13 and/or the BHA 26 are in communication with a surface processing unit 40. In one embodiment, the surface processing unit 40 is configured as a surface drilling control unit which controls various production and/or drilling parameters such as rotary speed, weight-on-bit, fluid flow parameters, pumping parameters and others and records and displays real-time formation evaluation data. In one embodiment, the DTS assembly 13 is directly connected to the surface processing unit 40. The BHA 26 incorporates any of various transmission media and connections, such as wired connections, fiber optic connections, wireless connections and mud pulse telemetry

In one embodiment, the DTS box 38 and/or the surface processing unit 40 include components as necessary to provide for storing and/or processing data collected from various sensors therein. Exemplary components include, without limitation, at least one processor, storage, memory, input devices, output devices and the like.

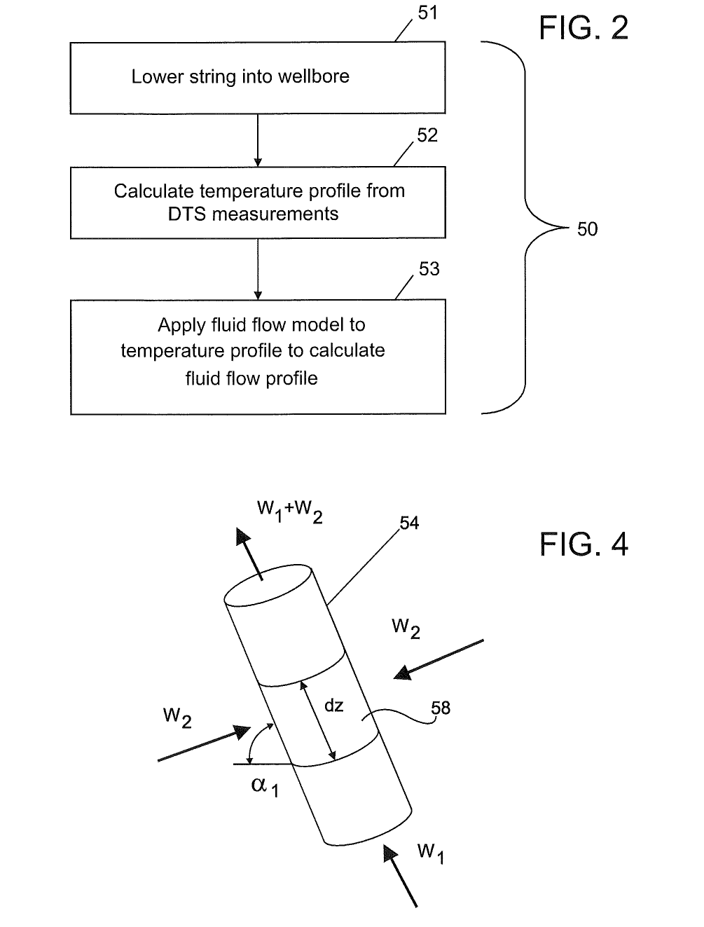

FIG. 2 illustrates a method 50 of calculating a temperature and/or flow profile of a wellbore. The method 50 is used in conjunction with the DTS assembly 38 and/or the surface processing unit 40, although the method 50 may be utilized in conjunction with any suitable combination of temperature sensing devices and processors. The method 50 includes one or more stages 51, 52 and 53. In one embodiment, the method 50 includes the execution of all of stages 51-53 in the order described. However, certain stages may be omitted, stages may be added, or the order of the stages changed.

In the first stage 51, a drillstring, logging string and/or production string is disposed within the wellbore 12.

In the second stage 52, the DTS assembly 13 is utilized to take temperature data from the surrounding wellbore fluid. In one embodiment, the temperature data is a plurality of signals induced at various locations along the optical fiber that form a temperature profile.

In one embodiment, the temperature along the length of the wellbore is taken by generating laser light pulses by the DTS box 38 and emitting the pulses into the optical fiber. As the laser pulses travel down the length of the optical fiber, portions of the light are reflected back to the DTS box 38 and measured by the DTS box 38. For example, the intensity ratio of Stokes to Anti-Stokes backscatter is used to calculate temperature along the optical fiber.

A processor such as the surface processing unit 40 or the DTS box 38 calculates a temperature profile. As described herein, a fluid flow or temperature profile includes one or more fluid flow or temperature measurements, each associated with a specific location along the optical fiber. A sufficient number of measurements are taken, for example, to generate a continuous temperature and/or fluid flow profile.

In the third stage 53, one or more fluid flow parameters are calculated based on a model of the temperature as a function of flow rates in one or more production zones. As described herein, a “production zone” refers to any portion of the length of the wellbore in which formation material such as oil, gas, water or other materials enter the wellbore. In these zones, the formation material intermixes with the wellbore fluid. The model described herein is able to generate fluid flow parameters of a section of the wellbore 12 that includes one or more production zones. The model calculates estimated fluid flow parameters, such as a mass rate of fluid at various depths in a wellbore segment, based on measured temperatures according to one or more of the mathematical relationships described herein. The model may also be used to calculate estimated temperatures based on known fluid flow parameters.

In one embodiment, the temperature data and/or the fluid flow data are presented as a respective data profile or curve relative to a depth of the wellbore. In another embodiment, such curves are processed using methods that include statistical analysis, data fitting, and data modeling to produce a temperature and/or fluid flow curve. Examples of statistical analysis include calculation of a summation, an average, a variance, a standard deviation, t-distribution, a confidence interval, and others. Examples of data fitting include various regression methods, such as linear regression, least squares, segmented regression, hierarchal linear modeling, and others.

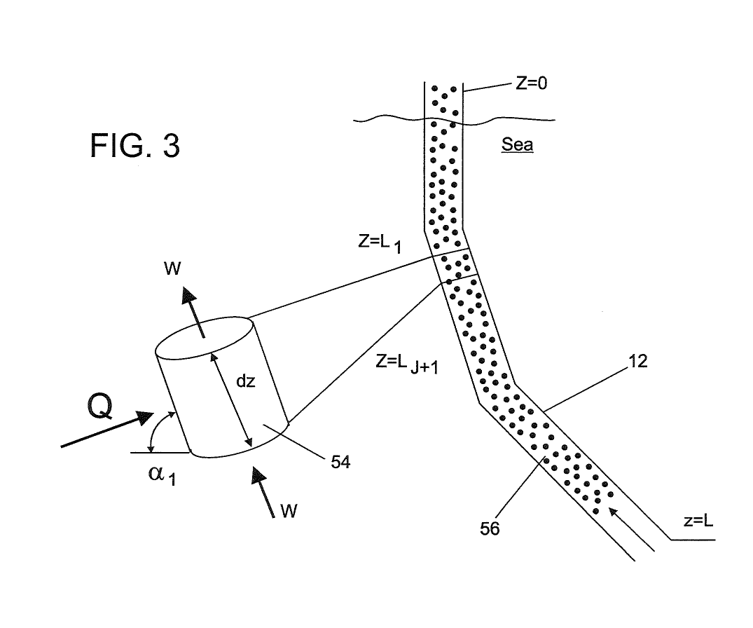

Referring to FIG. 3, the following relationships describe parameters for an energy equation in a portion of the wellbore 12 that does not include a production zone. The wellbore 12 in this example includes a number of sections having different deviations. FIG. 3 shows a control segment 54 having a specific volume, also referred to as “j”, of a non-production zone of the wellbore 12. As referred to herein, a “non-production zone” is a selected volume of the wellbore 12 having side surfaces that are not in direct fluid communication with the formation and/or a reservoir. A “production zone” is a selected volume of the wellbore 12 having side surfaces that are in direct fluid communication with the formation and/or the reservoir. In formation zones, perforations or other mechanisms allow gas and/or fluid to flow directly from the formation and/or reservoir into the volume. FIG. 3 and equations (1)-(9) are applicable to non-production zones.

The temperature difference between wellbore fluid 56 and the surrounding formation results in an energy exchange. During steady-state operation of the wellbore 12, the energy balance is represented by the following equation:

$$\frac{d H}{d z} - \frac{g ( sin α )}{{Jg}_{c}} + \frac{v}{{Jg}_{c}} \frac{d v}{d z} = - \frac{Q}{w} , \qquad ( 1 )$$

where “H” is the fluid enthalpy in Btu/lbm, “z” is the variable well depth from the surface in ft, “g” is the gravitational acceleration in ft/sec², “α” is the wellbore inclination angle relative to a horizontal line perpendicular to the direction of gravity, “J” is a Btu to ft.lb. conversion factor, “g_{c}” is a conversion factor of 32.17 ibm-ft/lbf/sec², “ν” is fluid velocity in ft/s, “Q” is a heat flow rate per unit length of wellbore in Btu/hr-ft-° F., and “w” is the fluid mass rate in lbm/hr.

“Q” represents the heat lost from the hot fluid 56 inside the wellbore 12 to the surrounding formation. For a fluid undergoing no phase change, the enthalpy H is a function of pressure and temperature and is represented by the following equation:

$$d H = {( \frac{\partial H}{\partial T} )}_{p} d T + {( \frac{\partial H}{\partial p} )}_{T} d p = {c}_{p} d T - {C}_{J} {c}_{p} d p , \qquad ( 2 )$$

where “T” or “T_{f}” is the fluid temperature in ° F., “p” is the pressure in psi, “cₚ” is the mean specific heat capacity of the fluid in Btu/lbm-° F. at constant pressure, and “C_{J}” is the Joule-Thomson coefficient in (° F.)/(lb/ft²). Hence, the equation for the wellbore fluid temperature as a function of measured distance along the segment 54 is represented by the following equation:

$$\frac{d {T}_{f}}{d z} = {C}_{J} \frac{d p}{d z} + \frac{1}{{c}_{p}} [ - \frac{Q}{w} + \frac{g ( sin α )}{{Jg}_{c}} - \frac{v}{{Jg}_{c}} \frac{d v}{d z} ] , \qquad ( 3 )$$

The heat flux per unit of wellbore, “Q”, is represented by the following equation:

Q=−L_{R}wcₚ(T_{f}−Tₑᵢ), (4)

where “L_{R}” is a relaxation parameter in ft⁻¹ and “Tₑᵢ” is the temperature of an undisturbed earth formation in ° F. The relaxation parameter L_{R} depends on fluid and formation thermal properties and an overall heat transfer coefficient “U”. Equations (5a) and (5b) represent L_{R} for a wellbore section surrounded by earth, and a wellbore section surrounded by water, respectively:

$$\begin{matrix}{L}_{R} = \frac{2 π}{{c}_{p} w} [ \frac{{r}_{to} {U}_{to} {k}_{e}}{{k}_{e} + ( {r}_{to} {U}_{to} {T}_{D} )} ] , \\ and & ( 5 a ) \\ {L}_{R} = \frac{2 π {r}_{to} {U}_{toc}}{{c}_{p} w} , & ( 5 b )\end{matrix}$$

where “Uₜₒ” is the overall heat transfer coefficient for the wellbore section 54 surrounded by earth, and “U_{toc}” is the overall heat transfer coefficient for the wellbore section 54 surrounded by water. “rₜₒ” is a radius of the wellbore section, “kₑ” is the thermal conductivity of the earth formation in Btu/hr-ft-° F. and “T_{D}” is a dimensionless temperature.

Combining the above equations yields the following equation for fluid temperature:

$$\frac{d {T}_{f}}{d z} = {L}_{R} ( {T}_{f} - {T}_{ei} ) + \frac{g ( sin α )}{{c}_{p} {Jg}_{c}} - φ , \qquad ( 6 )$$

where φ is represented by:

$$φ = \frac{v}{{Jc}_{p} {g}_{c}} \frac{d v}{d z} - {C}_{J} \frac{d p}{d z} . \qquad ( 7 )$$

The pressure gradient, “dp/dz”, is the sum of a kinetic pressure head “(dp/dz)_{A}”, a static pressure head “(dp/dz)_{H}” and a frictional pressure head “(dp/dz)_{F}” from the wellbore 12, represented by:

$$\frac{d p}{d z} = {( \frac{d p}{d z} )}_{A} + {( \frac{d p}{d z} )}_{H} + {( \frac{d p}{d z} )}_{F} . \qquad ( 8 )$$

The temperature of the undisturbed earth formation Tₑᵢ represents the surrounding undisturbed earth or sea temperature far away from the wellbore 12, which can be obtained through a geothermal temperature survey. For wellbores with multiple changes in inclination angle α or a geothermal gradient “g_{Gj}” (in ° F./ft), a temperature “Tₑᵢ₍ⱼ₊₁₎” of a given section may be expressed in terms of a temperature “Tₑᵢ₍ⱼ₎” of an adjacent previous section:

Tₑᵢ₍ⱼ₊₁₎=Tₑᵢ₍ⱼ₎−(Zⱼ−z)g_{Gj} sin αⱼ, (9)

where “Zⱼ” is a well depth at section node “j” and “αⱼ” is the inclination angle of the section “j”.

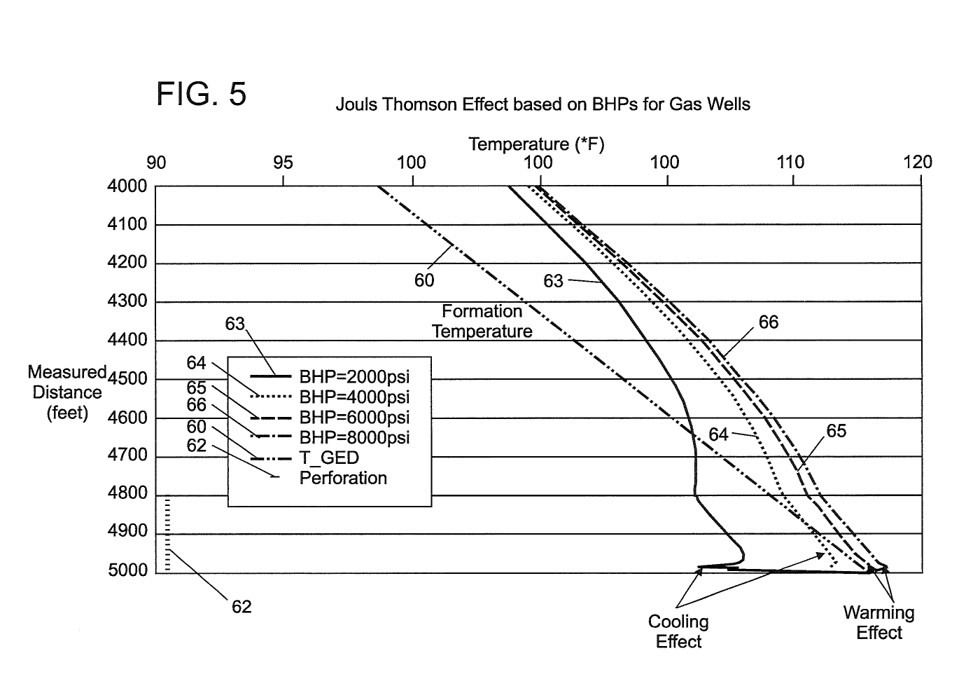

Referring to FIG. 4, the following relationships describe parameters for an energy equation for the segment 54 that includes a production zone 58. This portion experiences a fluid mass rate both from the wellbore 12 and the formation. During steady-state operation of the wellbore 12, the energy balance is represented by the following equation:

$$- Q = {w}_{1} ( \frac{d H}{d z} - \frac{g ( sin α )}{{Jg}_{c}} + \frac{v}{{Jg}_{c}} \frac{d v}{d z} ) + \frac{{w}_{2} {c}_{p} ( {T}_{f} - {T}_{entry} )}{d z} . \qquad ( 10 )$$

where “w₁” is the mass rate of fluid in the wellbore, “w₂” is the mass rate of fluid entering the wellbore 12 from the formation, and “T_{entry}” is the temperature of the fluid entering the wellbore 12 from the formation through the production zone 58. Inserting equations (2) and (4) into equation (10) yields the following differential equation:

$$\frac{d {T}_{f}}{d z} + \frac{( 1 - λ )}{λ} \frac{( {T}_{f} - {T}_{entry} )}{d z} = \frac{{L}_{R}}{λ} ( {T}_{ei} - {T}_{f} ) + ( \frac{g ( sin α )}{{Jg}_{c} {c}_{p}} - φ ) , \qquad ( 11 )$$

where “λ” is represented by the following:

$$λ = \frac{{w}_{1}}{{w}_{1} + {w}_{2}} \qquad ( 12 )$$

In a non-production wellbore portion, λ=1, and equation (11) for a production wellbore reduces to equation (6) for a non-production wellbore. Equation (11) can be solved, for example, by using the finite difference method.

The difference between the production zone entry temperature “T_{entry}” and the borehole fluid temperature “Tₑᵢ” is represented by the following equation:

$${T}_{entry} - {T}_{ei} = \frac{{C}_{J} ( {P}_{RES} - {P}_{wf} )}{- {J}_{c}} \qquad ( 13 )$$

where J_{C} is a conversion factor. “P_{RES}−P_{wf}” is the pressure drop in a reservoir surrounding the section. At the bottom of the wellbore, the pressure drop is assumed as the pressure drawdown. In one embodiment, if the formation temperature, pressure drop and fluid entry temperature are known, equation (13) can also be used to calculate the Joule-Thomson coefficient C_{J}.

The use of equations (6) and (11) require values for the Joule-Thomson coefficient C_{J} for the flowing fluid 56. The Joule-Thomson coefficient C_{J} represents the rate of change of the temperature T with respect to pressure p at a constant enthalpy H. The Joule-Thomson coefficient C_{J} can be applied for a single-phase gas, a single-phase liquid or a multiphase mixture of gas and liquid. The Joule-Thomson coefficient C_{J} is derived from Maxwell identities, and is represented by the following equation:

$${C}_{J} = \frac{1}{{c}_{P}} ( \frac{xT}{Z {ρ}_{g}} {( \frac{\partial Z}{\partial T} )}_{P} - ( 1 - x ) ( 1 - T β ) / {ρ}_{L} ) , \qquad ( 14 )$$

where “β” is a liquid volume expansion factor of 1/° F., “x” is the mass fraction of gas in a two-phase mixture, “ρ_{g}” is gas density and “ρ_{L}” is liquid density

An illustration of the Joule-Thomson effect is shown in FIG. 5. As shown therein, the cooling effect of the formation on the borehole fluid, for a single gas phase (x=1), depends on a gas compressibility factor at two different temperatures at a constant pressure p or (∂Z/∂T)ₚ. At lower pressures, the gas compressibility factor increases as temperature increases, resulting in a cooling effect. At higher pressures, the opposite phenomenon appears. For example, FIG. 5 shows the formation temperature (shown as curve 60) and the temperature of the gas at various bottomhole pressures (BHP) with a constant pressure drawdown. Note that in this example, a formation zone is formed between 4800 and 5000 feet, as shown by perforations 62. As shown by curve 63, when the BHP equals 2000 psi, the gas entry temperature begins at 111.4° F., which is 6.4° F. less than the formation temperature of 117.8° F. This cooling effect becomes weaker as BHP is increased, as shown by curve 64, which shows that at 4000 psi the temperature differences reduces to 1.4° F. As shown in curve 65, as BHP increases further to 6000 psi, a warming effect emerges. This warming effect increases at 8000 psi, as shown in curve 66.

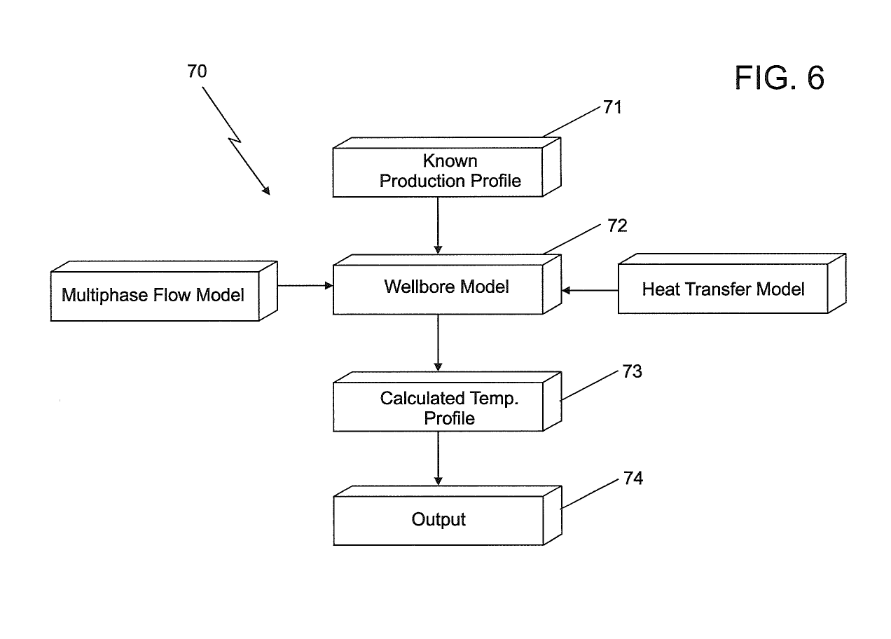

FIG. 6 shows a forward simulation method 70 that involves applying the model to predict a temperature distribution for a known production profile. In this method, a known production profile 71 is entered into the wellbore model 72, such as by entering selected information into equation (11) to calculate an estimated temperature profile 73. The estimated temperature profile is provided as output 74 to a user for analysis. In one embodiment, the method 70 is used in comparison with measured temperatures to calibrate the model 72. For calibration, fluid flow parameters are adjusted until the model 72 produces a predicted temperature that matches the measured temperature.

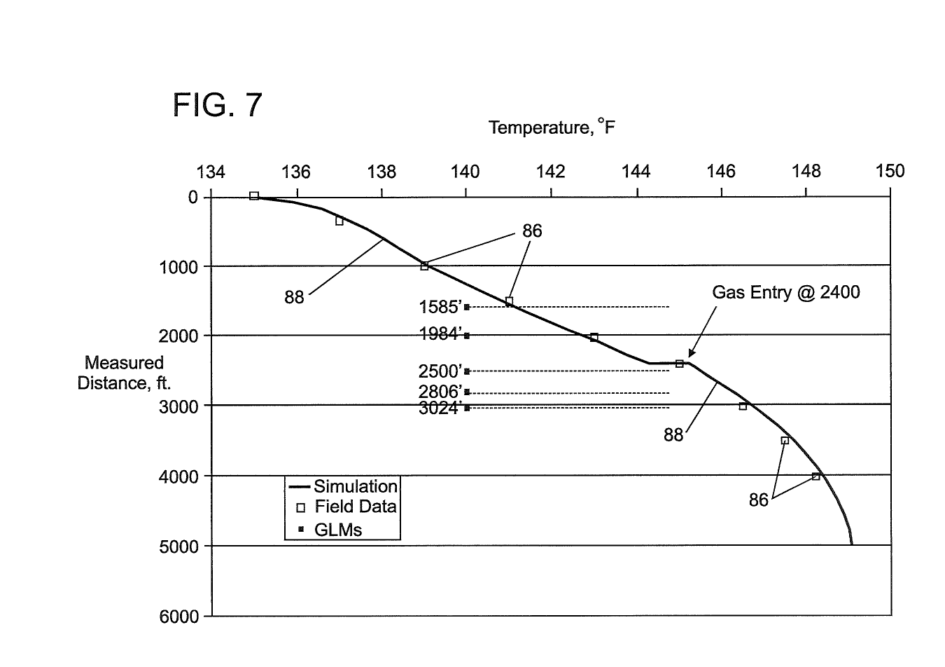

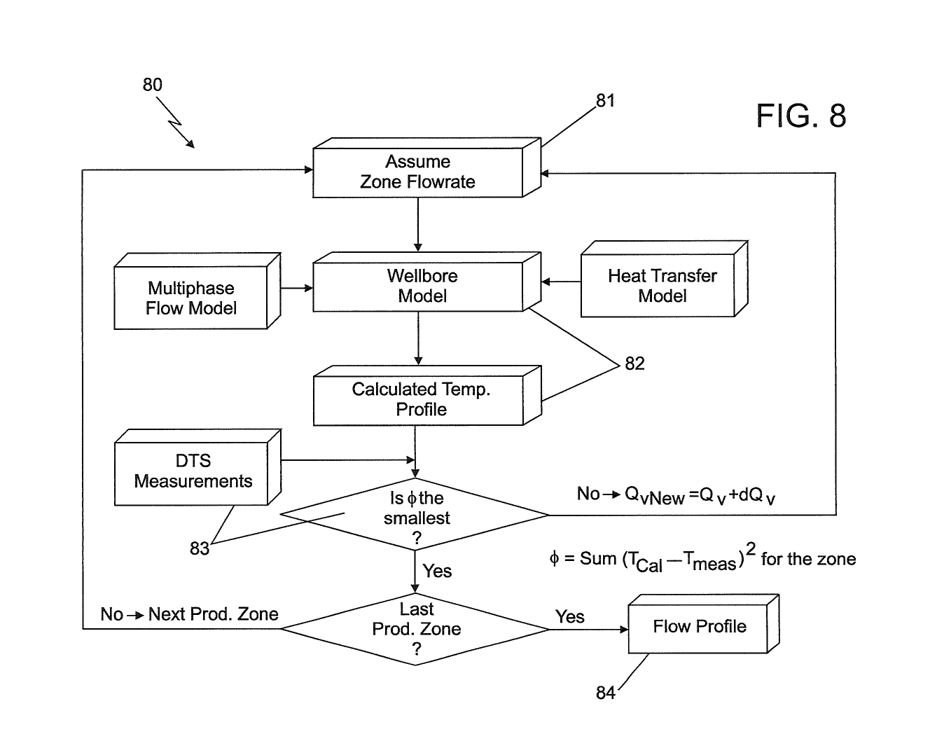

An example of the estimated temperature profile produced by the method 70 is shown in FIG. 7, which demonstrates the ability of the method 70 to be used for emulating “what-if” scenarios, such as forecast and gas lift surveillance. FIG. 7 shows an example of monitoring the performance of a well's gas lift mandrels by using the method 70. By inputting production and injection rates, the simulated temperature 88 calculated from the method 70 matches measured field data 86. Note that in this example, gas injection location is shown at 2400 ft, between two valves (located at 1984 ft and 2500 ft), which suggests that the valve was misplaced.

FIG. 8 shows a method 80 of applying the model 72 to estimate production profile parameters based on measured temperatures, such as those measured by the DTS assembly 13. The method 80 is repeated for a plurality of layers between the bottom of the wellbore 12 and the surface. The following stages are performed for each layer.

In the first stage 81, a plurality of assumed flow rates are selected. For example, a minimum flow rate, a maximum flow rate and a flow rate interval is selected.

In the second stage 82, starting from the bottom layer, a forward simulation is performed by inputting the assumed flow rate into the model and calculating an estimated temperature for the respective layer. The estimated temperature is calculated for each assumed flow rate.

In the third stage 83, the estimated temperatures are compared to the measured DTS temperature for the respective layer. In one embodiment, a summation of the estimated temperature “T_{cal}” and the measured DTS temperature “Tₘₑₐₛ” is calculated for each selected flow rate. The summation is represented by, for example, (T_{cal}−Tₘₑₐₛ)². The selected flow rate corresponding to the smallest summation value is determined to be the flow rate for that layer.

In the third stage 84, the comparison is repeated for each layer of the wellbore 12. When the flow rates for each layer are calculated based on the comparison, each flow rate is outputted to a user as a flow rate profile for the wellbore 12.

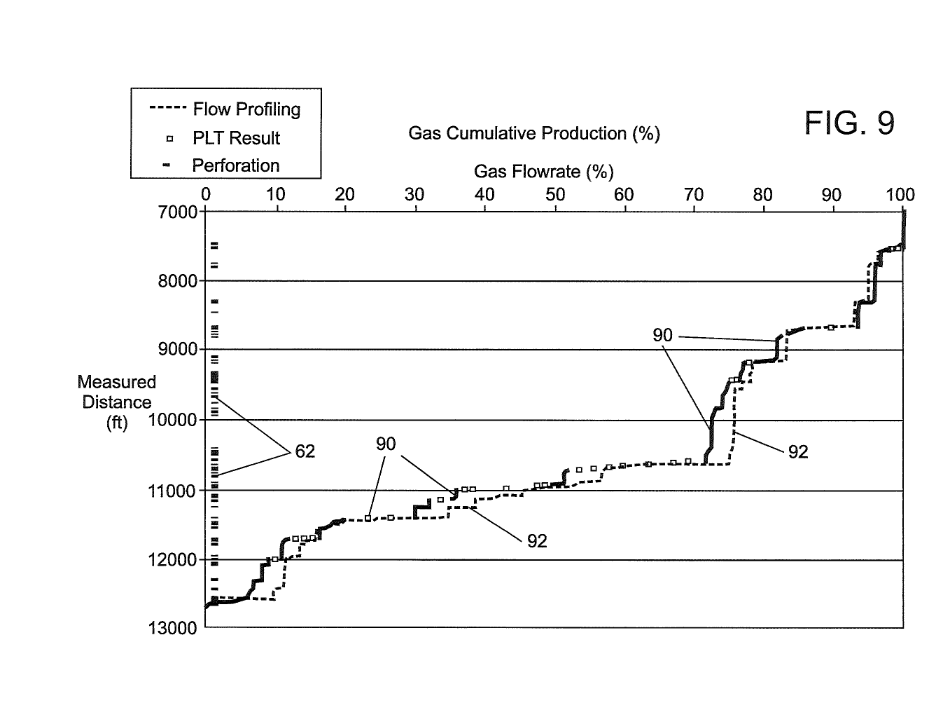

Examples of temperature and flow rate profiles utilizing the methods described herein are shown in FIG. 9. The data shown in FIG. 9 is representative of a low permeability gas well with sixty production zones 62. Flow rate 90 is the flow rate analysis result using conventional Production Logging Tools (PLT) test. A flow rate profile 92 is calculated based on the methods described herein. Very good agreement is shown between the PLT data 90 and the flow rate profile 92 calculated using the model 72.

Generally, some of the teachings herein are reduced to an algorithm that is stored on machine-readable media. The algorithm is implemented by a computer or processor such as the surface processing unit 40 or the DTS box 38 and provides operators with desired output. For example, data may be transmitted in real time from the distributed sensor to the surface processing unit 74 for processing.

The systems and methods described herein provide various advantages over prior art techniques. The systems and methods described herein are useful in well monitoring, zonal fluid contribution as well as identification of unwanted fluid entry. In contrast to prior art techniques, the systems and methods described herein provide for more accurate flow information as they take into account both fluid flows and gas/fluid mixtures. Accordingly, continuous, real-time flow information can be provided for the length of the wellbore.

In addition, the model described herein has a complexity that is significantly less than the complexity of prior art models. Accordingly, the model described herein has a wider range of application than prior art models.

Furthermore, the model described herein is advantageous in that it can be applied to segments of a wellbore that contain one or more production zones. For example, models proposed by H. J. Ramey Jr. in 1962 couple heat transfer mechanisms in the wellbore and transient thermal behavior of a formation reservoir, which are applicable for either single-phase incompressible hot liquid or single phase ideal gas flow in a line-source well. Models proposed by Sagar et al. in 1991, Alves et al. in 1992 and Hasan-Kabir-Wang in 1994 were extended to apply for two phase flows. These models include sever assumptions of thermodynamic behavior and are inadequate for complex problems. In 2007, Hasan-Kabir-Wang proposed a steady-state model for fluid temperature that divides the wellbore into many sections of uniform thermal properties and deviation angles. However, this model is not applicable to sections that include production zones. The systems and methods described herein overcome these deficiencies.

In support of the teachings herein, various analyses and/or analytical components may be used, including digital and/or analog systems. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing aspects of the teachings herein. For example, a sample line, sample storage, sample chamber, sample exhaust, pump, piston, power supply (e.g., at least one of a generator, a remote supply and a battery), vacuum supply, pressure supply, refrigeration (i.e., cooling) unit or supply, heating component, motive force (such as a translational force, propulsional force or a rotational force), magnet, electromagnet, sensor, electrode, transmitter, receiver, transceiver, controller, optical unit, electrical unit or electromechanical unit may be included in support of the various aspects discussed herein or in support of other functions beyond this disclosure.

One skilled in the art will recognize that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A system for measuring a fluid flow rate in a wellbore disposed in an earth formation, the system comprising:
a wellbore assembly configured to be disposed along a length of a wellbore, the wellbore configured to receive a wellbore fluid therein;
a distributed temperature sensor (DTS) assembly disposed along the length of the wellbore and configured to take a plurality of temperature measurements along the length of the wellbore; and
a processor in operable communication with the fiber optic sensor, the processor configured to receive the temperature measurements and apply a fluid flow rate model of fluid flow rates to the temperature measurements to calculate a fluid flow profile of the wellbore, the model based on a steady-state energy balance between the wellbore fluid and the earth formation and a Joule-Thomson coefficient including a liquid volume expansion factor and a fraction of gas in the wellbore fluid.

2. The system of claim 1, wherein the DTS assembly includes an optical fiber disposed along the length of the wellbore.

3. The system of claim 1, wherein the fluid flow profile is calculated by inputting a fluid flow rate value into the model and adjusting the fluid flow rate value until a temperature produced by the model is equivalent to a temperature measured by the DTS assembly.

4. The system of claim 1, wherein the processor is configured to calibrate the fluid flow model by using the fluid flow model to calculate an estimated temperature profile based on known fluid flow parameters and comparing the estimated temperature profile with a temperature profile measured by the DTS assembly.

5. The system of claim 1, wherein the selected length includes at least one production zone.

6. The system of claim 5, wherein the fluid flow profile includes a first fluid flow through an interior of the wellbore and a production fluid flow from the earth formation into the production zone.

7. The system of claim 5, wherein the fluid flow profile is calculated based on the following equation:
$$\frac{d {T}_{f}}{d z} + \frac{( 1 - λ )}{λ} \frac{( {T}_{f} - {T}_{entry} )}{d z} = \frac{{L}_{R}}{λ} ( {T}_{ei} - {T}_{f} ) + ( \frac{g ( sin α )}{{Jg}_{c} {c}_{p}} - φ ) ,$$
“T_{f}” is the wellbore fluid temperature, “z” is a variable well depth from a surface location, “T_{entry}” is a temperature of the production fluid entering the wellbore from the earth formation through the production zone, “L_{R}” is a relaxation parameter, “Tₑᵢ” is a temperature of an undisturbed earth formation, “g” is a gravitational acceleration, “α” is a wellbore inclination angle, “J” and “g_{c}” are conversion factors, “cₚ” is a mean specific heat capacity of the wellbore fluid at constant pressure, “φ” is represented by:
$$φ = \frac{v}{{Jc}_{p} {g}_{c}} \frac{d v}{d z} - {C}_{J} \frac{d p}{d z} ,$$
“ν” is a fluid velocity, “C_{J}” is the Joule-Thomson coefficient, “λ” is represented by:
$$λ = \frac{{w}_{1}}{{w}_{1} + {w}_{2}} ,$$
“w₁” is the mass rate of fluid in the wellbore, and “w₂” is the mass rate of fluid entering the wellbore from the earth formation.

8. The system of claim 7, wherein the wellbore fluid is a mixture of gas and liquid, the Joule-Thomson coefficient is calculated based on the following equation:
$$( \frac{xT}{Z {ρ}_{g}} {( \frac{\partial Z}{\partial T} )}_{P} - ( 1 - x ) ( 1 - T β ) / {ρ}_{L} ) , \qquad ( 14 )$$
“T” is a temperature of the mixture, “x” is a mass fraction of gas in the mixture, “Z” is a gas compressibility factor, “β” is a liquid volume expansion factor of 1/° F., and “p” is a fluid pressure, “ρ_{g}” is gas density and “ρ_{L}” is liquid density.

9. A method of measuring a fluid flow rate in a wellbore disposed in an earth formation, the method comprising:
disposing a wellbore assembly along a length of the wellbore;
circulating wellbore fluid through an interior of the wellbore;
taking a plurality of temperature measurements along the length of the wellbore by a distributed temperature sensor (DTS) assembly disposed along the length of the wellbore; and
applying a fluid flow rate model to the temperature measurements to calculate a fluid flow profile of the wellbore, the model based on a steady-state energy balance between the wellbore fluid and the earth formation and a Joule-Thomson coefficient including a liquid volume expansion factor and a fraction of gas in the wellbore fluid.

10. The method of claim 9, wherein the fluid flow profile is calculated by inputting a fluid flow rate value into the model and adjusting the fluid flow rate value until a temperature produced by the model is equivalent to a temperature measured by the DTS assembly.

11. The method of claim 9, further comprising calibrating the fluid flow model by using the fluid flow model to calculate an estimated temperature profile based on known fluid flow parameters and comparing the estimated temperature profile with a temperature profile measured by the DTS assembly.

12. The method of claim 9, wherein the selected length includes at least one production zone, and the fluid flow profile includes a first fluid flow through an interior of the wellbore and a production fluid flow from the earth formation into the production zone.

13. The method of claim 12, wherein the fluid flow profile is calculated based on the following equation:
$$\frac{d {T}_{f}}{d z} + \frac{( 1 - λ )}{λ} \frac{( {T}_{f} - {T}_{entry} )}{d z} = \frac{{L}_{R}}{λ} ( {T}_{ei} - {T}_{f} ) + ( \frac{g ( sin α )}{{Jg}_{c} {c}_{p}} - φ ) ,$$
“T_{f}” is the wellbore fluid temperature, “z” is a variable well depth from a surface location, “T_{entry}” is a temperature of the production fluid entering the wellbore from the earth formation through the production zone, “L_{R}” is a relaxation parameter, “Tₑᵢ” is a temperature of an undisturbed earth formation, “g” is a gravitational acceleration, “α” is a wellbore inclination angle, “J” and “g_{c}” are conversion factors, “cₚ” is a mean specific heat capacity of the wellbore fluid at constant pressure, “φ” is represented by:
$$φ = \frac{v}{{Jc}_{p} {g}_{c}} \frac{d v}{d z} - {C}_{J} \frac{d p}{d z} ,$$
“ν” is a fluid velocity, “C_{J}” is the Joule-Thomson coefficient, “λ” is represented by:
$$λ = \frac{{w}_{1}}{{w}_{1} + {w}_{2}} ,$$
“w₁” is the mass rate of fluid in the wellbore, and “w₂” is the mass rate of fluid entering the wellbore from the earth formation.

14. The method of claim 13, wherein the wellbore fluid is a mixture of gas and liquid, the Joule-Thomson coefficient is calculated based on the following equation:
$${C}_{J} = \frac{1}{{c}_{P}} ( \frac{xT}{Z {ρ}_{g}} {( \frac{\partial Z}{\partial T} )}_{P} - ( 1 - x ) ( 1 - T β ) / {ρ}_{L} ) , \qquad ( 14 )$$
“T” is a temperature of the mixture, “x” is a mass fraction of gas in the mixture, “Z” is a gas compressibility factor, “β” is a liquid volume expansion factor of 1/° F., and “p” is a fluid pressure, “ρ_{g}” is gas density and “ρ_{L}” is liquid density.

15. A computer program product stored on machine readable media for of measuring a fluid flow rate in a wellbore disposed in an earth formation by executing machine implemented instructions, the instructions for:
disposing a wellbore assembly along a length of the wellbore;
circulating wellbore fluid through an interior of the wellbore;
taking a plurality of temperature measurements along the length of the wellbore by a distributed temperature sensor (DTS) assembly disposed along the length of the wellbore; and
applying a fluid flow rate model of fluid flow rates to the temperature measurements to calculate a fluid flow profile of the wellbore, the model based on a steady-state energy balance between the wellbore fluid and the earth formation and a Joule-Thomson coefficient including a liquid volume expansion factor and a fraction of gas in the wellbore fluid.

16. The computer program product of claim 15, wherein the fluid flow profile is calculated by inputting a fluid flow rate value into the model and adjusting the fluid flow rate value until a temperature produced by the model is equivalent to a temperature measured by the DTS assembly.

17. The computer program product of claim 15, wherein the instructions include instructions for calibrating the fluid flow model by using the fluid flow model to calculate an estimated temperature profile based on known fluid flow parameters and comparing the estimated temperature profile with a temperature profile measured by the DTS assembly.

18. The computer program product of claim 15, wherein the selected length includes at least one production zone, and the fluid flow profile includes a first fluid flow through an interior of the wellbore and a production fluid flow from the earth formation into the production zone.

19. The computer program product of claim 18, wherein the fluid flow profile is calculated based on the following equation:
$$\frac{d {T}_{f}}{d z} + \frac{( 1 - λ )}{λ} \frac{( {T}_{f} - {T}_{entry} )}{d z} = \frac{{L}_{R}}{λ} ( {T}_{ei} - {T}_{f} ) + ( \frac{g ( sin α )}{{Jg}_{c} {c}_{p}} - φ ) ,$$
“T_{f}” is the wellbore fluid temperature, “z” is a variable well depth from a surface location, “T_{entry}” is a temperature of the production fluid entering the wellbore from the earth formation through the production zone, “L_{R}” is a relaxation parameter, “Tₑᵢ” is a temperature of an undisturbed earth formation, “g” is a gravitational acceleration, “α” is a wellbore inclination angle, “J” and “g_{c}” are conversion factors, “cₚ” is a mean specific heat capacity of the wellbore fluid at constant pressure, “φ” is represented by:
$$φ = \frac{v}{{Jc}_{p} {g}_{c}} \frac{d v}{d z} - {C}_{J} \frac{d p}{d z} ,$$
“ν” is a fluid velocity, “C_{J}” is the Joule-Thomson coefficient, “λ” is represented by:
$$λ = \frac{{w}_{1}}{{w}_{1} + {w}_{2}} ,$$
“w₁” is the mass rate of fluid in the wellbore, and “w₂” is the mass rate of fluid entering the wellbore from the earth formation.

20. The computer program product of claim 19, wherein the wellbore fluid is a mixture of gas and liquid, the Joule-Thomson coefficient is calculated based on the following equation:
$${C}_{J} = \frac{1}{{c}_{P}} ( \frac{xT}{Z {ρ}_{g}} {( \frac{\partial Z}{\partial T} )}_{P} - ( 1 - x ) ( 1 - T β ) / {ρ}_{L} ) , \qquad ( 14 )$$
“T” is a temperature of the mixture, “x” is a mass fraction of gas in the mixture, “Z” is a gas compressibility factor, “β” is a liquid volume expansion factor of 1/° F., and “p” is a fluid pressure, “ρ_{g}” is gas density and “ρ_{L}” is liquid density.
